(19) United States
(12) Patent Application Publication
(10) Pub. No.: US 2022/0018722 A1
(43) Pub. Date: Jan. 20, 2022

(54) TORQUE DETECTION SENSOR

(71) Applicant: SHINANO KENSHI KABUSHIKI KAISHA, Nagano (JP)

(72) Inventor: Akihide FURUKAWA, Nagano (JP)

(21) Appl. No.: 17/340,221

(22) Filed: Jun. 7, 2021

(30) Foreign Application Priority Data
Jul. 17, 2020 (JP) 2020-122672

(51) Int. Cl. G01L 3/10

(52) U.S. Cl. CPC G01L 3/102

(57) ABSTRACT

A torque detection sensor includes first teeth and second teeth provided to protrude in staggered arrangement in an annular core and plural energizing circuits in which first coils and second coils wound around the first teeth and the second teeth are connected in series, in which plural magnetic paths having inclinations of ±45 degrees with respect to an axial center direction are respectively formed through an object to be detected between the first teeth and the second teeth by energization to the plural energizing circuits.

### CROSS-REFERENCE TO RELATED APPLICATION

This application is based upon and claims the benefit of priority of the prior Japanese Patent Application No. 2020-122672, filed on Jul. 17, 2020, and the entire contents of which are incorporated herein by reference.

### TECHNICAL FIELD

The present invention relates to a self-excitation torque detection sensor.

### BACKGROUND ART

There exists a magnetostrictive torque detection device as a method for detecting torque acting on an object to be detected such as a rotary shaft by a non-contact manner. For example, surface treatment (for example, plating, grooving, or the like) for increasing magnetostrictive characteristics is performed on the surface of a shaft to be detected distortion of which is detected, and magnetostrictive effect is measured to detect the torque. The measurement of the magnetostrictive effect is executed by arranging coils coaxially wound around the shaft and reading variation in magnetic permeability of the shaft generated by Villari effect based on the magnitude of impedance.

As the torque detection device, the applicants have proposed a magnetostrictive torque detection sensor in which magnetic paths formed between the object to be detected and a plurality of cores assembled to insulation cylindrical bodies so that the magnetic paths formed at the object to be detected have a prescribed angle with respect to its axis center are respectively increased to thereby improve torque detection sensitivity. The plural cores are disposed in an inclined manner at a prescribed angle with respect to an axial center direction of the object to be detected so that end faces of both side leg portions face the object to be detected from inner circumferential surfaces of the insulation cylindrical bodies. As the cores formed in a U-shape are disposed in the inclined manner at the prescribed angle with respect to the axial center of the object to be detected, an independent magnetic path passing one leg portion (end surface), the object to be detected, the other leg portion (end surface), and a bridge portion is formed. As described above, the same magnetic field is generated around the coil as the same coil passes through the plural cores, which forms the same pole. Accordingly, magnetic fluxes are concentrated to the cores and a magnetic path connecting adjacent cores to each other is not easily formed; therefore, a structure in which detection sensitivity is improved can be obtained (PTL 1: Japanese Patent No. 6483778).

### SUMMARY OF INVENTION

### Technical Problem

However, in the torque detection device of the above patent literature, it is necessary to form grooves on an outer peripheral surface of the insulation cylindrical bodies and to wind the plural detection coils along the grooves, and further, the plural cores are assembled to the insulation cylindrical bodies so that the detection coils pass through a U-shaped space surrounded by the bridge portion connecting the leg portions.

Accordingly, it is necessary to embed the detection coils and the cores by utilizing the thickness of the insulation cylindrical bodies in a radial direction; therefore, the sensor tends to be increased in size in the radial direction and an axial direction. As the end faces of both side leg portions forming the cores are provided so as to face the object to be detected, the shape of end faces has to be, not a flat surface, but an arc-shaped curved surface, which increases processing costs.

There is also a demand that torque is delicately detected over the entire periphery of the object to be detected without reducing detection sensitivity.

### Solution to Problem

In response to the above issue, one or more aspects of the present invention are directed to a self-excitation torque detection sensor capable of reducing the size of the sensor and being mass produced at low cost as well as capable of detecting compressive stress and tensile stress generated over the entire periphery of an object to be detected without reducing detection sensitivity.

In view of the above, the following embodiments are described below.

A torque detection sensor measures variation of magnetic permeability by variation of coil impedance in magnetic circuits formed between a core and an object to be detected by energizing coils wound around teeth provided to protrude from the annular core provided around the object to be detected at plural places, including plural first teeth and second teeth provided to protrude in staggered arrangement in the annular core in a circumferential direction, and a plurality of energizing circuits in which first coils and second coils with different winding directions wound around the first teeth and the second teeth are connected in series, in which a plurality of magnetic paths having an inclination of +45 degrees and a plurality of magnetic paths having an inclination of −45 degrees with respect to an axial center direction are respectively formed through the object to be detected between the first teeth and the second teeth by energization to the plural energizing circuits.

According to the above configuration, the sensor includes the first teeth and the second teeth provided to protrude in staggered arrangement in the annular core in the circumferential direction and the plural energizing circuits in which the first coils and the second coils with different winding directions wound around the first teeth and the second teeth are connected in series; therefore, the annular core, the first teeth and the second teeth can be manufactured through manufacturing processes similar to a laminated core used for a stator core of a motor, and the first coils and the second coils can be wound by using a winding machine, as a result, the sensor can be reduced in size in the radial direction as well as in the axial direction and can be mass produced at low cost.

Moreover, the plural magnetic paths having the inclination of +45 degrees and the plural magnetic paths having the inclination of −45 degrees with respect to the axial center direction are respectively formed through the object to be detected between the first teeth and the second teeth by energization to the plural energizing circuits; therefore, variation of magnetic permeability is measured as variation of coil impedance in the plural magnetic circuits to thereby delicately detect compressive stress and tensile stress generated over the entire periphery of the object to be detected without reducing detection sensitivity.

It is preferable that the first coils and the second coils connected to the same energizing circuit in series are respectively wound around the first teeth and the second teeth forming the magnetic paths having the inclination of +45 degrees with respect to the axial center direction, that the first coils and the second coils connected to the same energizing circuit in series are respectively wound around the first teeth and the second teeth forming the magnetic paths having the inclination of −45 degrees with respect to the axial center direction, and that the first teeth and the second teeth adjacent to each other in the annular core in the circumferential direction are alternately excited to N-poles and S-poles.

Accordingly, the first coils and the second coils connected to the same energizing circuit in series are respectively wound around the first teeth and the second teeth forming the magnetic paths having inclination of ±45 degrees, and the first teeth adjacent to each other and the second teeth adjacent to each other in the circumferential direction are alternately excited to N-poles and S-poles, thereby respectively forming plural magnetic paths having the inclination of +45 degrees and plural magnetic paths having the inclination of −45 degrees with respect to the axial center direction which are effective for detecting the torque, as a result, diversity of wiring in energizing circuits is increased with arbitrary layouts, and wiring becomes easy.

It is preferable that a torque detection sensor includes a first energizing circuit performing energization from the first coil wound around the first tooth to the second coil wound around the second tooth having a phase difference of +45 degrees in the circumferential direction, and performing energization from the second coil wound around another second tooth wired in the circumferential direction to the first coil wound around another first tooth having the phase difference of +45 degrees, and a second energizing circuit performing energization from the first coil wound around the first tooth to the second coil wound around the second tooth having a phase difference of −45 degrees and performing energization from the second coil wound around another second tooth wired in the circumferential direction to the first coil wound around another first tooth having the phase difference of −45 degrees.

Accordingly, when the power is supplied to the first energizing circuit, energization is made from the first coil wound around the first tooth to the second coil wound around the second tooth having the phase difference of +45 degrees in the circumferential direction, then, energization is made from the second coil wound around another second tooth wired in the circumferential direction to the first coil wound around another first tooth having the phase difference of +45 degrees to thereby form plural magnetic paths having the inclination of +45 degrees with respect to the axial center direction.

When the power is supplied to the second energizing circuit, energization is made from the first coil wound around the first tooth to the second coil wound around the second tooth having the phase difference of −45 degrees, then, energization is made from the second coil wound around another second tooth wired in the circumferential direction to the first coil wound around another first teeth having the phase difference of −45 degrees to thereby form plural magnetic paths having the inclination of −45 degrees with respect to the axial center direction.

Accordingly, compressive stress and tensile stress generated over the entire periphery of the object to be detected can be detected.

The sensor may be a self-excitation sensor measuring variation of magnetic permeability by variation of coil impedance in magnetic circuits formed between the core and the object to be detected by energizing the first coils wound around the first teeth and the second coils wound around the second teeth provided to protrude in staggered arrangement in the core.

In this case, the first coils and the second coils are energized at arbitrary timing, thereby forming the plural magnetic paths having the inclination of +45 degrees and the plural magnetic paths having the inclination of −45 degrees with respect to the axial center direction between the core and the object to the detected and detecting compressive stress and tensile stress acting on the object to be detected.

### Advantageous Effects of Invention

It is possible to reduce the size of the sensor and to mass produce the sensor at low cost as well as to detect compressive stress and tensile stress generated over the entire periphery of the object to be detected without reducing detection sensitivity.

### BRIEF DESCRIPTION OF DRAWINGS

FIG. 1 shows an exploded view of a core, an explanatory view for energizing circuits, and an explanatory view for magnetic paths formed between teeth according to Embodiment 1.

FIG. 2 is an explanatory view for the magnetic paths formed between the teeth in FIG. 1.

FIG. 3 shows a developed view of a core, an explanatory view for energizing circuits, and an explanation view for magnetic paths formed between teeth according to Embodiment 2.

FIG. 4 is an explanatory view for magnetic paths formed between core magnetic poles in FIG. 3.

FIG. 5 shows a developed view of a core, an explanatory view for energizing circuits, and an explanation view for magnetic paths formed between teeth according to Embodiment 3.

FIG. 6 is an explanatory view for the magnetic paths formed between the teeth in FIG. 5.

FIGS. 7A to 7D are a front view, a right-side view, a cross-sectional view taken along an arrow Y-Y, and a perspective view of a torque detection sensor.

FIGS. 8A to 8C are a front view, a right-side view, and a perspective view of a torque detection sensor according to another example of FIG. 7.

FIGS. 9A to 9C are a front view, a right-side view, and a perspective view of a torque detection sensor according to another example of FIG. 7.

FIGS. 10A to 10C are explanatory views showing an assembly configuration of a yoke and a core according to another embodiment.

FIGS. 11A to 11C are an exploded front view, a plan view, and an exploded perspective view of a torque detection sensor according to another embodiment.

FIGS. 12A and 12B are explanatory views showing an assembly configuration of a yoke and a core in FIG. 11.

FIGS. 13A to 13C are a front view, a right-side view, and a perspective view of a torque detection sensor and an object to be detected according to another embodiment.

FIG. 14 shows a developed view of a core, an explanatory view for energizing circuits, and an explanatory view for magnetic circuits formed between core magnetic poles according to a comparative example of Embodiment 1.

FIGS. 15A and 15B are explanatory views for structures in which plural coils are wound around one tooth.

FIG. 16 shows a developed view of a core, an explanatory view for energizing circuits, and an explanatory view for magnetic circuits formed between core magnetic poles according to a comparative example of Embodiment 2.

FIG. 17 shows a developed view of a core, an explanatory view for energizing circuits, and an explanatory view for magnetic circuits formed between core magnetic poles according to a comparative example 3 of Embodiment 3.

### DESCRIPTION OF EMBODIMENTS

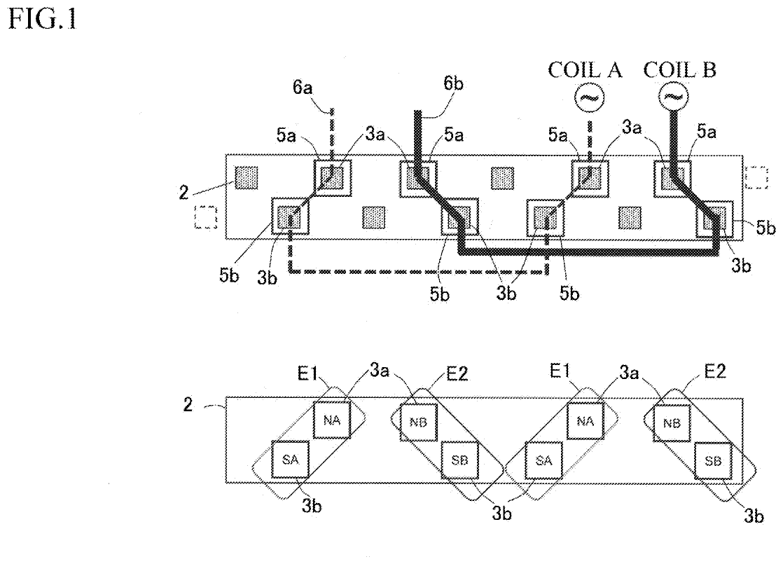

Hereinafter, a torque detection sensor according to an embodiment of the present invention will be explained with reference to the attached drawings. First, a schematic configuration of a torque detection sensor 1 will be explained with reference to FIG. 1 to FIGS. 13A to 13C.

As an example of an object to be detected, a material with high inverse magnetostrictive effect is preferable. For example, there are permendur, Fe—Al (ALFE), Fe-Nix (permalloy), spherical graphite cast iron (JIS: FCD70), and the like as materials with high inverse magnetostrictive effect. The inverse magnetostrictive effect is a phenomenon in which magnetic characteristics are changed when stress is added to a magnetic body from the outside. When magnetic annealing is previously performed to the object to be detected according to need, the torque acting on the object to be detected can be suitably detected, which will be described in detail later. Even in a non-magnetic material, the torque can be detected by coating the material with a metal magnetic material by performing thermal spraying or by press-fitting a magnetic cylinder into a shaft. An object to be detected S has a columnar shape, but the shape is not limited to this. An internal structure does not matter as long as the object to be detected has the columnar shape. For example, a cylindrical shape in which an inner diameter is fixed in an axial direction or a cylindrical shape in which the inner diameter differs according to positions in the axial direction may be adopted. Moreover, the object to be detected may be an object expected to rotate as well as an object not expected to rotate. Furthermore, the object to be detected may be a solid shaft material as well as a hollow shaft or the like.

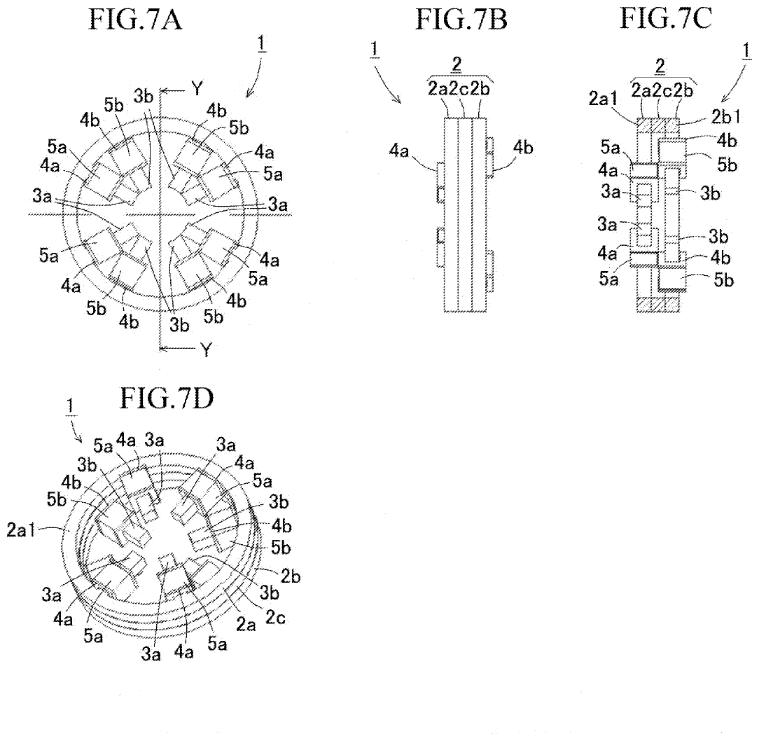

As shown in FIG. 1, a plurality of first teeth 3a and second teeth 3b are provided to protrude in staggered arrangement in an annular core 2 in a circumferential direction. As shown in FIG. 7B, the annular core 2 is formed so that a first core 2a and a second core 2b are stacked through an intermediate core 2c to be integrally joined by caulking, adhesion, or combinations of them. In the first core 2a, four first teeth 3a in total are provided to protrude in the circumferential direction with a predetermined phase difference as well as at opposite positions toward an inner side in a radial direction. In the second core 2b, four second teeth 3b in total are provided to protrude in the circumferential direction with a predetermined phase difference as well as at opposite positions toward the inner side in the radial direction. As shown in FIGS. 7A to 7D, the first core 2a and the second core 2b are stacked through the intermediate core 2c so that phases of the first teeth 3a and the second teeth 3b differ by 45 degrees in the circumference direction. Accordingly, the first teeth 3a and the second teeth 3b are provided to protrude on an inner peripheral surface of the core 2 in staggered arrangement as shown in a developed view of the core 2 in FIG. 1. There are no teeth protruding toward the inner side of the radial direction in the intermediate core 2c. Explanation will be made by representing the component in which plural cores 2a to 2c are stacked merely as the core 2 in developed views below.

The first core 2a having the first teeth 3a, the second core 2b having the second teeth 3b, and the intermediate core 2c may be, for example, formed by stacking electromagnetic steel sheets which are press molded, or may be integrally formed from a magnetic material into a block shape. It is also preferable to use the core 2 manufactured by using a sintered body, metal powder injection molding, and green compact. A configuration of a laminated type will be explained below.

In the first core 2a, a plurality of first teeth 3a which are four in total, are provided to protrude in an annular core back portion 2a1 with a predetermined phase difference in the circumferential direction as well as at opposite positions toward the inner side in the radial direction. A cylindrical first insulator 4a made of insulating resin is fitted to each of the first teeth 3a, and a first coil 5a is wound therearound.

In the second core 2b, a plurality of second teeth 3b which are four in total, are provided to protrude in an annular core back portion 2b1 with a predetermined phase difference in the circumferential direction as well as at opposite positions toward the inner side in the radial direction in the same manner as the first core 2a. A cylindrical second insulator 4b made of insulating resin is fitted to each of the second teeth 3b, and a second coil 5b is wound therearound.

Phase differences between the respective teeth may be the same as well as different from one another. The number of teeth may be an even number as well as an odd number.

The annular intermediate core 2c is provided between the first core 2a and the second core 2b. The intermediate core 2c doubles as a spacer for securing a space where the first coils 5a are wound around the first teeth 3a and the second coils 5b are wound around the second teeth 3b respectively between the first core 2a and the second core 2b, and magnetic paths between the first core 2a and the second core 2b.

FIG. 1 shows an exploded view of the core 2, an explanatory view for energizing circuits, and an explanatory view for magnetic paths formed between the teeth according to Embodiment 1. In FIG. 1, a winding direction of the first coils 5a wound around the first teeth 3a and a winding direction of the second coils 5b wound around the second teeth 3b are opposite. A plurality of energizing circuits to which the first coils 5a and the second coils 5b are connected in series are provided. Specifically, a first energizing circuit 6a (a broken line in an upper stage of FIG. 1) performs energization from the first coil 5a wound around the first tooth 3a to the second coil 5b wound around the second tooth 3b having a phase difference of +45 degrees in the circumferential direction, and performs energization from the second coil 5b wound around another second tooth 3b wired in the circumferential direction to the first coil 5a wound around another first tooth 3a having a phase difference of +45 degrees. More precisely, tip portions of the first teeth 3a facing the object to be detected and tip portions of the second teeth 3b facing the object to be detected are stacked through the intermediated core 2c so that the phase differs by +45 degrees in the circumferential direction. According to the energization to the first energizing circuit 6a (the broken line in the upper stage of FIG. 1), a plurality of magnetic paths (a lower stage of FIG. 1) having an inclination of +45 degrees with respect to an axial center direction are formed between the first teeth 3a and the second teeth 3b through the object to be detected.

A second energizing circuit 6b (a solid line in the upper stage of FIG. 1) performs energization from the first coil 5a wound around the first tooth 3a to the second coil 5b wound around the second tooth 3b having a phase difference of −45 degrees, and performs energization from the second coil 5b wound around another second tooth 3b wired in the circumferential direction to the first coil 5a wound around another first tooth 3a having a phase difference of −45 degrees. More precisely, tip portions of the first teeth 3a facing the object to be detected and tip portions of the second teeth 3b facing the object to be detected are stacked through the intermediated core 2c so that the phase differs by −45 degrees in the circumferential direction. According to the energization to the second energizing circuit 6b (the solid line in the upper stage of FIG. 1), a plurality of magnetic paths (the lower stage of FIG. 1) having an inclination of −45 degrees with respect to the axial center direction are respectively formed between the first teeth 3a and the second teeth 3b through the object to be detected. When the coils forming the first energizing circuit 6a are coils A and the coils forming the second energizing circuit 6b are coils B, NA in the drawing denotes teeth exited to N-pole by the coils A, SA denotes teeth excited to S-pole by the coils A. Similarly, NB in the drawing denotes teeth excited to N-pole by the coils B and SB denotes teeth exited to S-pole by the coils B. More precisely, tip portions of teeth facing the object to be detected are excited to N-pole or S-pole. Whether being excited to N-pole or excited to S-pole can be determined by inverting the direction in which the coils A and the coils B (the first coils 5a and the second coils 5b) are wound.

A long frame E1 surrounding NA and SA, and a long frame E2 surrounding NB and SB shown in the lower stage of FIG. 1 represent inclinations of magnetic paths with respect to the axial center direction (a vertical direction in the drawing) in the magnetic paths formed between the object to be detected and the first teeth 3a/the second teeth 3b. Note that teeth around which coils are not wound may exist in the first teeth 3a and the second teeth 3b arranged in staggered arrangement.

As the torque detection sensor 1 described above, a self-excitation torque detection sensor is used, which measures variation of magnetic permeability by variation of coil impedance in magnetic circuits formed between the teeth 3 and the object to be detected S by energizing the coils 5 wound around the teeth 3 facing the object to be detected S at plural positions therearound.

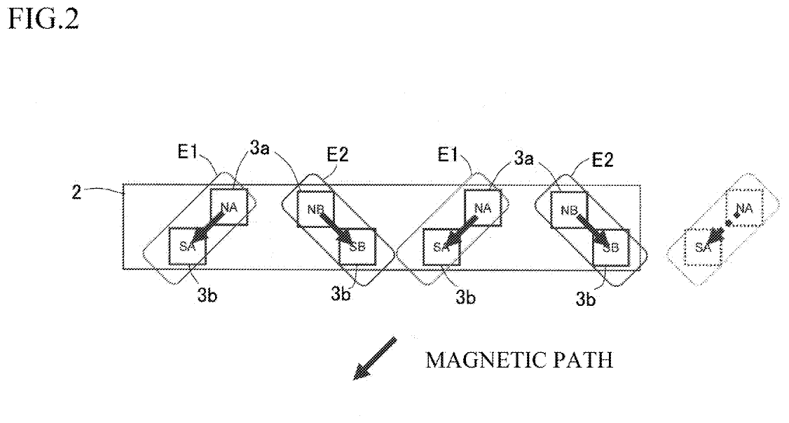

FIG. 2 is an explanatory view for magnetic paths formed between the first teeth 3a and the second teeth 3b. A plurality of magnetic paths in which the first teeth 3a are excited to N-poles and the second teeth 3b are excited to S-poles are shown. The long frame E1 surrounding NA and SA represents an inclination (+45 degrees) of the magnetic paths with respect to the axial center direction (the vertical direction in FIG. 2) at the time of energizing the first energizing circuit 6a. The long frame E2 surrounding NB and SB represents an inclination (−45 degrees) of the magnetic paths with respect to the axial center direction (the vertical direction in FIG. 2) at the time of energizing the second energizing circuit 6b. The magnetic paths inclined to +45 degrees and the magnetic paths inclined to −45 degrees are formed alternately in the circumferential direction of the core (see the long frames E1, E2).

In this case, magnetic poles of the first teeth 3a adjacent in the circumferential direction have the same polarity (N-pole) and magnetic poles of the second teeth 3b adjacent in the circumferential direction have the same polarity (S-pole); therefore, only magnetic-path components (±45 degrees) necessary for torque detection are formed, which can realize the torque detection efficiently.

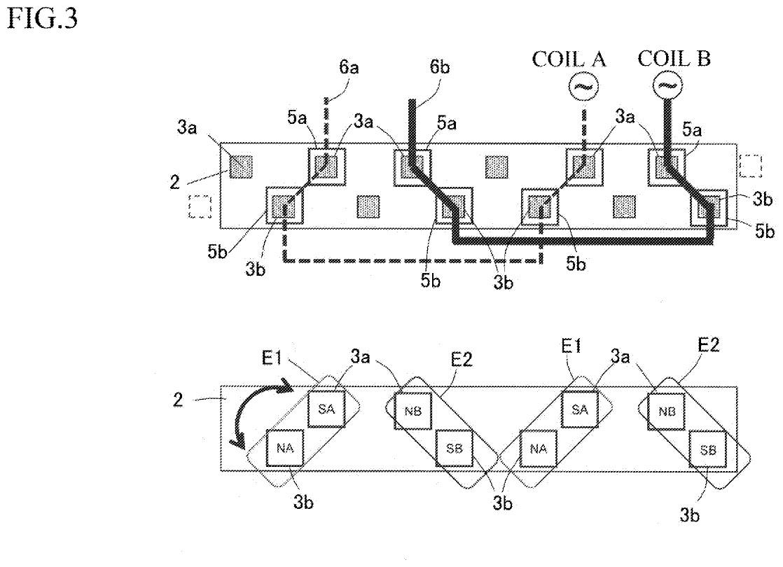

FIG. 3 shows a developed view of the core, an explanatory view for energizing circuits, and an explanation view for magnetic paths formed between teeth according to Embodiment 2. In an upper stage of FIG. 3, a plurality of magnetic paths (a lower stage of FIG. 3) having the inclination of +45 degrees with respect to the axial center direction are formed between the first teeth 3a and the second teeth 3b through the object to be detected by energization to the first energizing circuit 6a (a broken line in the upper stage of FIG. 3). A plurality of magnetic paths (the lower stage of FIG. 3) having the inclination of −45 degrees with respect to the axial center direction are respectively formed between the first teeth 3a and the second teeth 3b through the object to be detected by energization to the second energizing circuit 6b (a solid line in the upper stage of FIG. 3). The embodiment differs from Embodiment 1 (FIG. 1) in a point that the winding direction of the first coils 5a wound around the first teeth 3a and the winding direction of the second coils 5b wound around the second teeth 3b are opposite. Accordingly, the first teeth 3a are excited to S-pole and the second teeth 3b are excited to N-pole. The long frame E1 surrounding SA and NA and the long frame E2 surrounding SB and NB shown in the lower stage of FIG. 3 represent inclinations of magnetic paths with respect to the axial center direction (the vertical direction in the drawing) in the magnetic paths formed between the first teeth 3a and the second teeth 3b. Two long frames E2 are shown as examples in FIG. 3, and a combination in which the first tooth 3a is NB and the second tooth 3b is SB is formed in both frames. As other examples, one long frame E2 may be formed by a combination in which the first tooth 3a is SB and the second tooth 3b is NB and another long frame E2 may be formed by a combination in which the first tooth 3a is NB and the second tooth 3b is SB. Furthermore, one long frame E1 may be formed by a combination in which the first tooth 3a is SA and the second tooth 3b is NA and another long frame E2 may be formed by a combination in which the first tooth 3a is NA and the second tooth 3b is SA. As described above, whether the first teeth 3a and the second teeth 3b are excited to N-pole or S-pole in the long frame E1 and the long frame E2 is not specified.

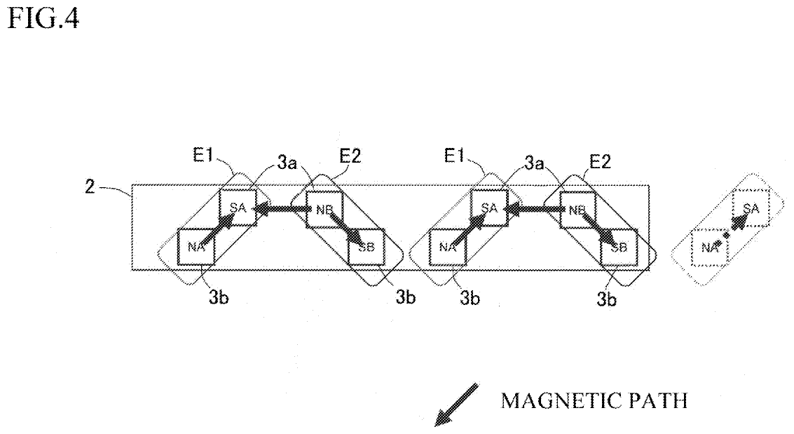

FIG. 4 is an explanatory view for magnetic paths formed between the first teeth 3a and the second teeth 3b. A plurality of magnetic paths in which the first teeth 3a are excited to S-poles or N-poles and the second teeth 3b are excited to N-poles or S-poles are shown. The long frame E surrounding SA and NA represents the inclination (+45 degrees) of the magnetic paths with respect to the axial center direction (the vertical direction of FIG. 4) at the time of energizing the first energizing circuit 6a. The long frame E2 surrounding SB and NB represents the inclination (−45 degrees) of the magnetic paths with respect to the axial center direction (the vertical direction of FIG. 4) at the time of energizing the second energizing circuit 6b. The magnetic paths inclined by +45 degrees and the magnetic paths inclined by −45 degrees are alternately formed in the circumferential direction of the core 2.

In this case, magnetic poles of the first teeth 3a adjacent in the circumferential direction have different polarities, and magnetic poles of the second teeth 3b adjacent in the circumferential direction also have different polarities; therefore, magnetic paths (NB-SA) in an arrow direction from N-pole toward S-pole are respectively formed between the first teeth 3a adjacent in the circumferential direction of FIG. 4, which is different from Embodiment 1. However, these magnetic paths have magnetic path components making little contribution to torque detection. Accordingly, these magnetic paths have little effect on detection sensitivity.

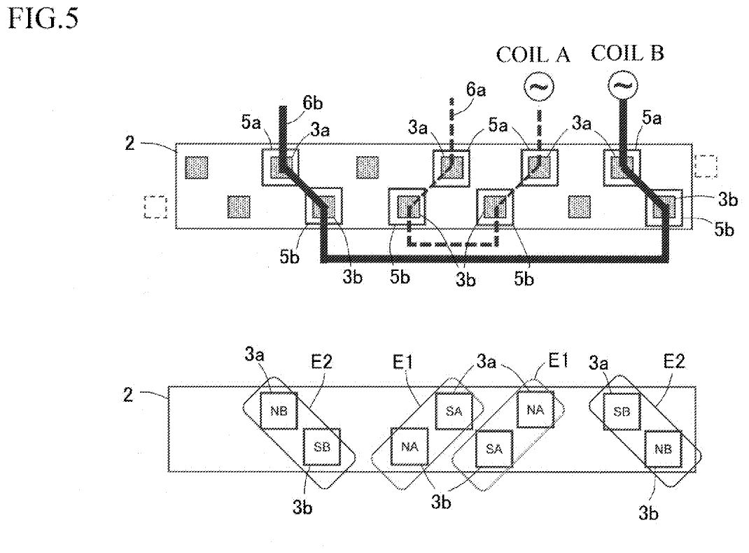

FIG. 5 shows a developed view of a core, an explanatory view for energizing circuits, and an explanation view for magnetic paths formed between teeth according to Embodiment 3. In FIG. 5, a plurality of magnetic paths (a lower stage of FIG. 5) having the inclination of +45 degrees with respect to the axial center direction are formed between the first teeth 3a and the second teeth 3b through the object to be detected by energization to the first energizing circuit 6a (a broken line in an upper stage of FIG. 5). A plurality of magnetic paths (the lower stage of FIG. 5) having the inclination of −45 degrees with respect to the axial center direction are respectively formed between the first teeth 3a and the second teeth 3b through the object to be detected by energization to the second energizing circuit 6b (a solid line in the upper stage of FIG. 5). The long frame E1 surrounding SA and NA represents the inclination (+45 degrees) of the magnetic paths with respect to the axial center direction (the vertical direction of FIG. 5) at the time of energizing the first energizing circuit 6a. The long frame E2 surrounding SB and NB represents the inclination (−45 degrees) of the magnetic paths with respect to the axial center direction (the vertical direction of FIG. 5) at the time of energizing the second energizing circuit 6b. The embodiment differs from Embodiments 1, 2 in a point that the magnetic paths inclined by +45 degrees and the magnetic paths inclined by −45 degrees are not alternately formed in the circumferential direction of the core (see the long frames E1, E2).

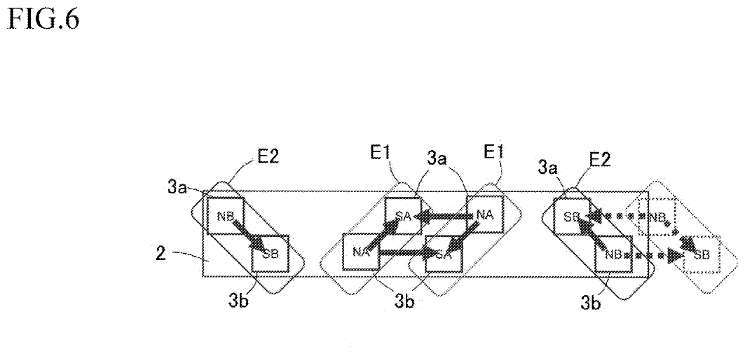

FIG. 6 is an explanatory view for the magnetic paths formed between the first teeth 3a and the second teeth 3b. The first teeth 3a are alternately excited to N-poles and S-poles in the circumferential direction of the core, and the second teeth 3b are alternately excited to S-poles and N-poles in the circumferential direction of the core.

In this case, magnetic poles of the first teeth 3a adjacent in the circumferential direction are different polarities, and magnetic poles of the second teeth 3b adjacent in the circumferential direction are also different polarities; therefore, magnetic paths (NA-SA), (NB-SA) in an arrow direction from N-pole toward S-pole are respectively formed between the first teeth 3a adjacent in the circumferential direction in FIG. 6 in addition to the magnetic paths inclined at ±45 degrees formed between the first teeth 3a and the second teeth 3b. Moreover, magnetic paths (NA-SA), (NB-SB) in an arrow direction from N-pole toward S-pole are respectively formed between the second teeth 3b adjacent in the circumferential direction. As these magnetic paths have components making little contribution to torque detection, these magnetic paths have little effect on detection sensitivity.

Here, configuration examples of the torque detection sensor will be explained with reference to FIGS. 7A to 7D to FIGS. 13A to 13C. In FIGS. 7A to 7D, the core 2 is formed by the annular first core 2a, intermediate core 2c, and second core 2b integrally stacked. The first core 2a is formed so that four first teeth 3a in total are provided to protrude in the annular core back portion 2a1 with a predetermined phase difference in the circumferential direction as well as at opposite positions toward the inner side in the radial direction. The second core 2b is formed so that four second teeth 3b in total are provided to protrude in the annular core back portion 2b1 with a predetermined phase difference in the circumferential direction as well as at opposite positions toward the inner side in the radial direction.

As shown in FIGS. 7A and 7D, the first core 2a and the second core 2b are stacked through the intermediate core 2c, and four pairs of the first teeth 3a and the second teeth 3b are stacked to each other with the phase difference of 45 degrees in the circumferential direction. Also as shown in FIGS. 7B and 7C, the intermediate core 2c is provided between the first teeth 3a and the second teeth 3b, thereby providing a space for winding. Accordingly, the number of turns of the first coils 5a to be wound around the first teeth 3a and the second coils 5b to be wound around the second teeth 3b can be increased, which generates more magnetic fluxes and improves detection sensitivity.

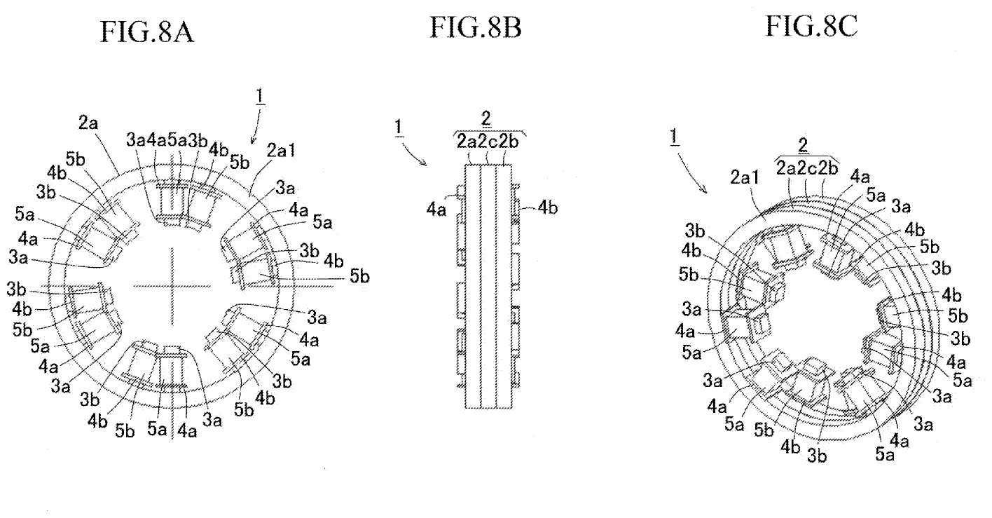

The torque detection sensor 1 shown in FIGS. 8A to 8C has the similar configuration to that shown in FIGS. 7A to 7D, but differs from that in points of the number of the first teeth 3a provided in the first core 2a and the number of the second teeth 3b provided in the second core 2b. The first core 2a is formed so that the first teeth 3a are provided to protrude in the annular core back portion 2a1 at six places in the circumferential direction with a phase difference of 60 degrees in the circumferential direction as well as at opposite positions toward the inner side in the radial direction. The second core 2b is formed so that the second teeth 3b are provided to protrude in the annular core back portion 2b1 (not shown) at six places in the circumferential direction with the phase difference of 60 degrees in the circumferential direction as well as at opposite positions toward the inner side in the radial direction. The first core 2a and the second core 2b are stacked through the intermediate core 2c, and six pairs of the first teeth 3a and the second teeth 3b are provided to be stacked with the phase difference of 45 degrees in the circumferential direction.

As described above, the number of the first teeth 3a and the number of the second teeth 3b provided to protrude in staggered arrangement in the circumferential direction of the first core 2a and the second core 2b are increased, thereby detecting torque variation acting on the object to be detected more delicately.

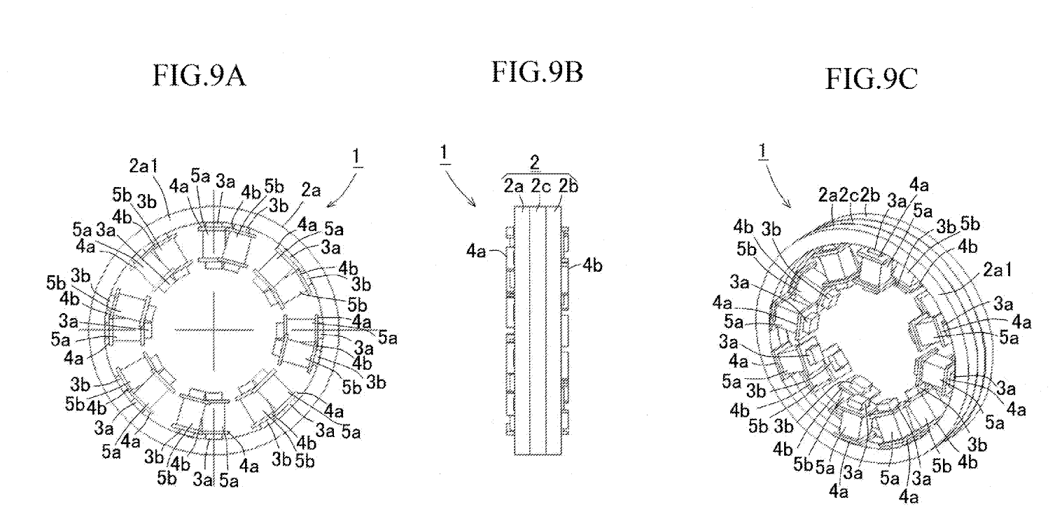

The torque detection sensor 1 shown in FIGS. 9A to 9C has the similar configurations to those shown in FIGS. 7A to 7D, FIGS. 8A to 8C, but differs from those in points of the number of the first teeth 3a provided in the first core 2a and the number of the second teeth 3b provided in the second core 2b. The first core 2a is formed so that the first teeth 3a are provided to protrude in the annular core back portion 2a1 at eight places in the circumferential direction with the phase difference of 45 degrees in the circumferential direction as well as at opposite positions toward the inner side in the radial direction. The second core 2b is formed so that the second teeth 3b are provided to protrude in the annular core back portion 2b1 (not shown) at eight places in the circumferential direction with the phase difference of 45 degrees in the circumferential direction as well as at opposite positions toward the inner side in the radial direction. The first core 2a and the second core 2b are stacked through the intermediate core 2c, and eight pairs of the first teeth 3a and the second teeth 3b are provided to be stacked with the phase difference of 45 degrees in the circumferential direction.

the number of the first teeth 3a and the number of the second teeth 3b provided to protrude in staggered arrangement in the circumferential direction of the first core 2a and the second core 2b are increased, thereby detecting torque variation acting on the object to be detected more delicately.

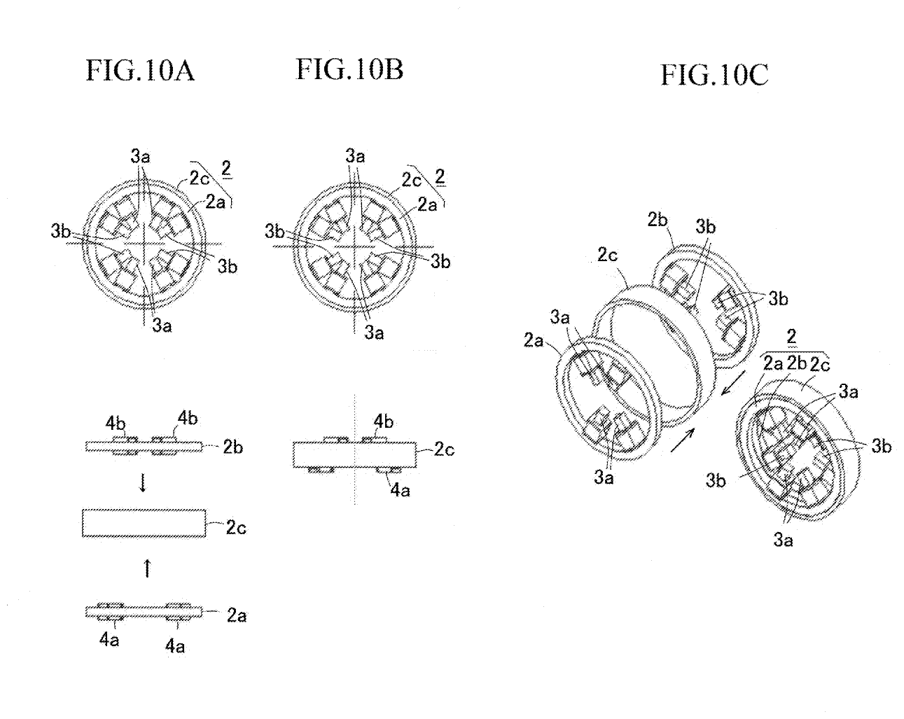

FIGS. 10A to 10C are explanatory views showing assembly configurations of a torque detection sensor according to another embodiment. Although the annular first core 2a, the intermediate core 2c, and the second core 2b having the same diameter are stacked in the axial direction to be integrally assembled as the core 2 in the same manner as FIGS. 7A to 7D in the above embodiments, it is also preferable that, for example, an outer diameter of the intermediate core 2c is formed to be larger than those of the first core 2a and the second core 2b and that the first core 2a and the second core 2b are concentrically fitted from both end openings of the intermediate core 2c.

FIG. 10A shows a plan view and a front exploded view of an opening end illustrating a state before the first core 2a and the second 2b are inserted into the intermediate core 2c. FIG. 10B shows a plan view and a front view of the opening end illustrating a state in which the first core 2a and the second core 2b are fitted to the intermediate core 2c from both end openings. FIG. 10C shows a perspective view illustrating states before and after the first core 2a and the second core 2b are inserted into the intermediate core 2c. It is also preferable that the first core 2a and the second core 2b inserted from both end openings of the intermediate core 2c are fitted with predetermined gaps as shown in FIG. 10C. As the intermediate core 2c is also the magnetic body, magnetic circuits are formed in the first teeth 3a and the second teeth 3b the phase of which differs by 45 degrees through the intermediate core 2c.

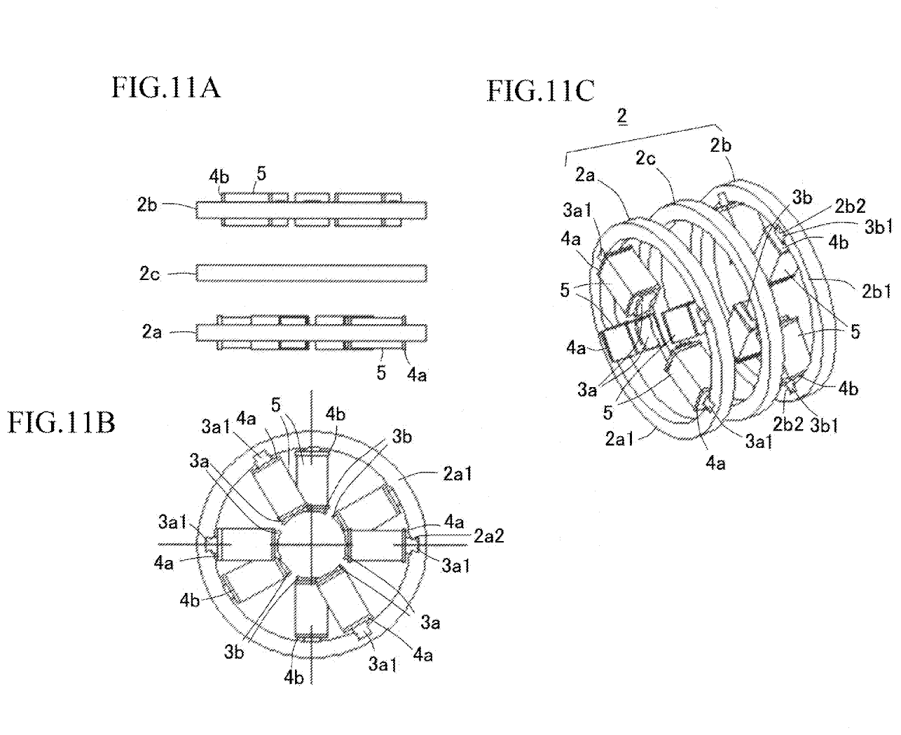

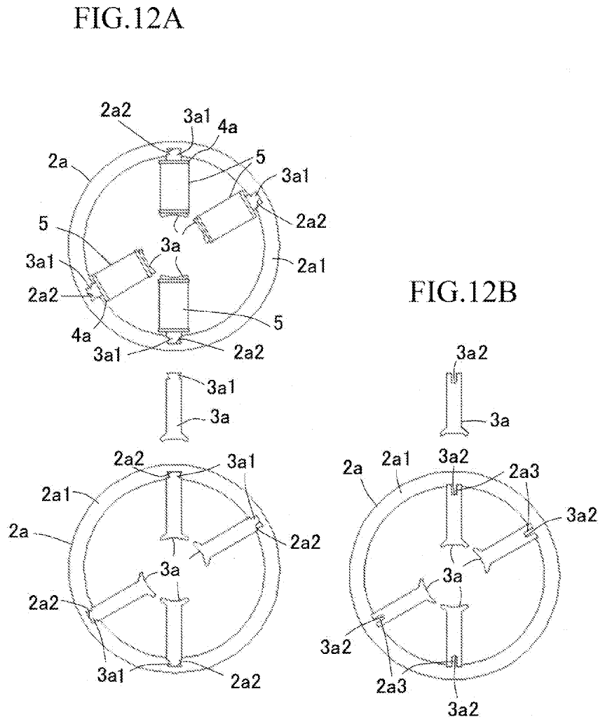

FIGS. 11A to 11C and FIGS. 12A, 12B show other configurations of the torque detection sensor 1.

The torque detection sensor 1 differs from the torque detection sensors shown in FIGS. 7A to 7D to FIGS. 9A to 9C in a point that the annular core back portion 2a1 is not integrally formed with the first teeth 3a and the annular core back portion 2b1 is not integrally formed with the second teeth 3b.

As shown in FIGS. 11A to 11C, four first teeth 3a in total are provided to protrude in the annular core back portion 2a1 with a predetermined phase difference in the circumferential direction as well as at opposite positions toward the inner side in the radial direction in the first core 2a. Four second teeth 3b are provided to protrude in the annular core back portion 2b1 with a predetermined phase difference in the circumferential direction as well as at opposite positions toward the inner side in the radial direction. The configuration is the same in points that the first core 2a and the second core 2b are stacked through the intermediate core 2c as well as the first teeth 3a and the second teeth 3b are provided so as to be stacked with the phase difference of 45 degrees in the circumferential direction.

As shown in FIG. 12A, the first teeth 3a are assembled so that engaging portions 3a1 provided at outer end portions of the first teeth 3a are fitted in the axial center direction into dovetail grooves 2a2 provided on an inner peripheral surface of the core back portion 2a1. In each of the first teeth 3a, the first insulator 4a is fitted in a state of being removed from the core back portion 2a1, and the first coil 5a is wound around the first insulator 4a. This is assembled so that the engaging portion 3a1 is fitted in the axial center direction into the dovetail groove 2a2 formed in the core back portion 2a1 of the first core 2a. As for an assembly structure of the second teeth 3b with respect to the core back portion 2b1 of the second core 2b, the second teeth 3b are assembled by fitting engaging portions 3b1 into dovetail grooves 2b2 in the axial center direction in the same manner as the first teeth 3a (see FIGS. 11A to 11C).

As shown in FIG. 12B, it is also preferable that projections 2a3 are formed on the inner peripheral surface of the core back portion 2a1 and recesses 3a2 are provided at outer end portions in the radial direction of the first teeth 3a and that the projections 2a3 are fitted into the recesses 3a2 to thereby assemble the first teeth 3a to the core back portion 2a1 toward the inner side of the radial direction. In this core state, the degree of freedom in assembling the first teeth 3a to the first core 2a and assembling the second teeth 3b to the second core 2b is high; therefore, assemblability is good.

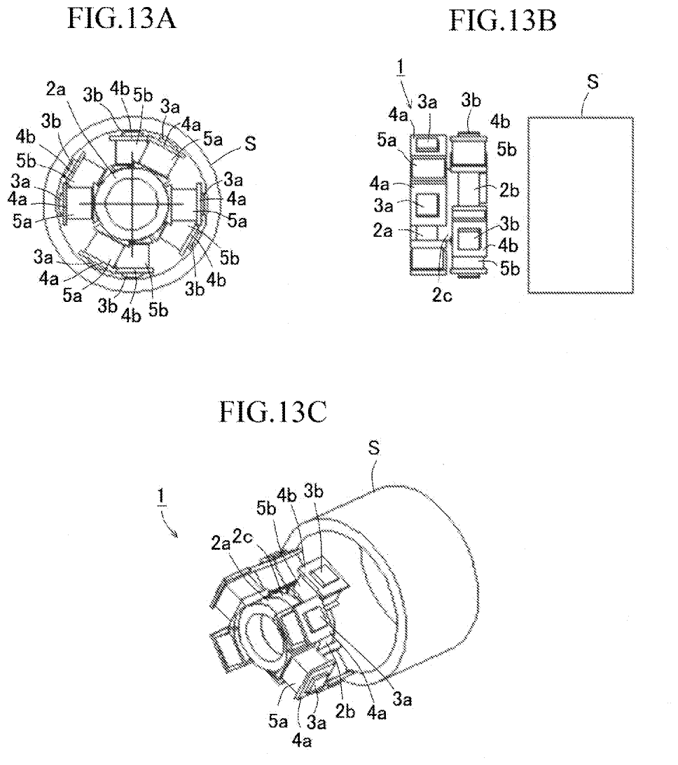

FIGS. 13A to 13C show another embodiment of the torque detection sensor. All embodiments shown in FIGS. 7A to 7D to FIGS. 12A to 12C relate to inner-type sensors in which a solid shaft material is assumed to be used as the object to be detected. That is, the teeth are provided to protrude in the core on the inner side in the radial direction. However, the type of the sensor is not limited to this, and an outer-type sensor in which torque variation can be detected even when the object to be detected is a cylindrical material (hollow shaft) may be adopted. That is, teeth are provided to protrude in the core on an outer side in the radial direction.

FIGS. 13A to 13C are a front view of the torque detection sensor, a side view and a perspective view showing a state before assembly.

In FIGS. 13A to 13C, the core 2 is formed so that the annular first core 2a, intermediate core 2c, and second core 2b are integrally stacked. In the first core 2a, four first teeth 3a in total are provided to protrude in the annular core back portion 2a1 in the circumferential direction with a predetermined phase difference as well as at opposite positions toward an outer side in the radial direction. In the second core 2b, four second teeth 3b in total are provided to protrude in the annular core back portion 2b1 in the circumferential direction with a predetermined phase difference as well as at opposite positions toward the outer side in the radial direction. The first coils 5a are wound around the first teeth 3a through the first insulators 4a, and the second coils 5b are wound around the second teeth 3b through the second insulators 4b. The first core 2a and the second core 2b are stacked through the intermediate core 2c, and the first teeth 3a and the second teeth 3b are stacked with the phase difference of 45 degrees in the circumferential direction to make, for example, four pairs of teeth.

The above-described torque detection sensor 1 is concentrically inserted into a hollow hole of the object to be detected S (hollow shaft), and the first teeth 3a and the second teeth 3a are assembled so as to face an inner peripheral surface of the object to be detected S. Accordingly, magnetic circuits including the object to be detected S are formed between the first teeth 3a and the second teeth 3a provided in the staggered arrangement, and torque variation can be detected from magnetic path components of ±45 degrees.

As described above, the sensor can detect torque variation of not only the solid shaft but also the hollow shaft as the object to be detected S, which improves versatility.

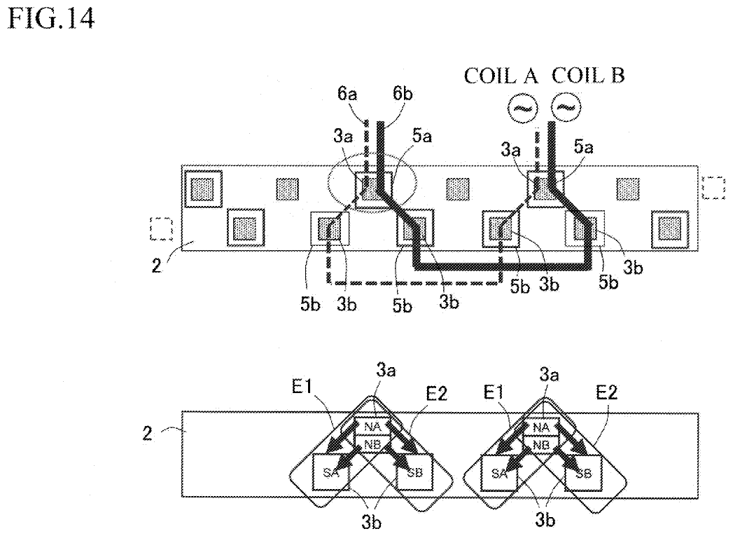

Here, comparative examples with respect to the above embodiments will be explained with reference to FIG. 14 to FIG. 17. Comparative explanation will be made below with reference to developed views of the core 2.

FIG. 14 is a comparative arrangement view of magnetic poles formed at the teeth by energization, which is not capable of being applied to the torque detection sensor 1 according to Embodiment 1 (FIG. 1). As shown in an upper stage of FIG. 14, two coils are not allowed to be wound around one tooth in the first teeth 3a and the second teeth 3b provided at staggered arrangement in the core 2.

For example, as shown in the upper stage of FIG. 14, the first coils 5a (NA) connecting to the first energizing circuit 6a (see a broken line) and the first coils 5a (NB) connecting to the second energizing circuit 6b (see a solid line) are wound around the first teeth 3a in common.

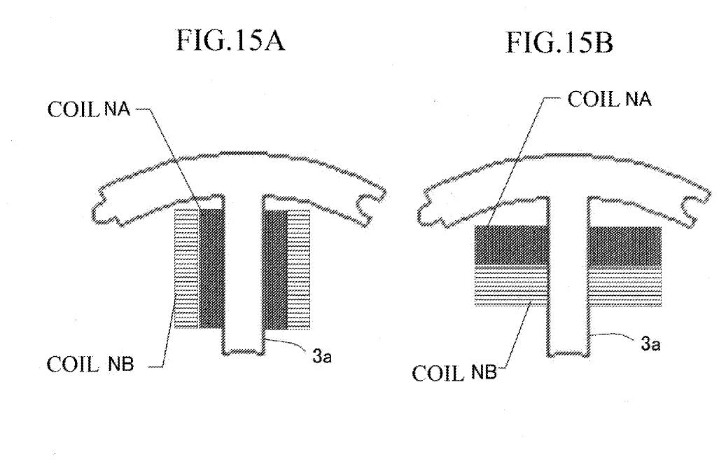

Specifically, there are a case where an NA coil is wound on an inner peripheral side of the first tooth 3a and an NB coil is wound on an outer peripheral side as shown in FIG. 15A, and a case where the NA coil is wound along a longitudinal direction of the first tooth 3a on an outer side in the radial direction and the NB coil is wound on an inner side in the radial direction.

In this case, as shown in a lower stage of FIG. 14, magnetic paths in arrow directions (NA→SA), (NB→SA) and magnetic paths in arrow directions (NA→SB), (NB→SB) having different inclinations are respectively formed between the first tooth 3a and the second tooth 3b so as to overlap on the same first tooth 3a (see the long frames E1, E2).

As described above, magnetic paths with +45 degrees (NA→SA and NB→SA) and magnetic paths with −45 degrees (NA→SB and NB→SB) in arrow directions are respectively formed between the same first tooth 3a and the plural second teeth 3b. Accordingly, magnetic fluxes become opposite to each other and cancelled out in adjacent magnetic paths formed between the first teeth 3a and the second teeth 3b, which reduces measurement sensitivity. Moreover, plural coils are wound around one tooth portion (the first tooth 3a); therefore, a generated magnetic flux amount is reduced and the measurement sensitivity is further reduced.

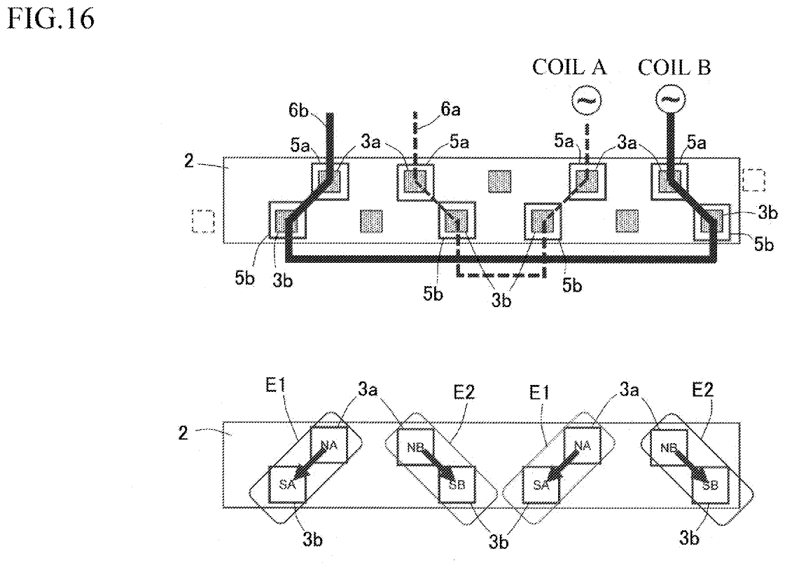

FIG. 16 is a comparative arrangement view of the core and magnetic poles formed at the teeth by energization, which is not capable of being applied to the torque detection sensor 1 according to Embodiment 2 (FIG. 3).

As shown in an upper stage of FIG. 16, it is difficult to measure torque components with different directions in the same energizing circuit. That is, the first energizing circuit 6a (see a broken line) is wound around the first teeth 3a and the second teeth 3b arranged at +45 degrees in the circumferential direction and is also wound around the first teeth 3a and the second teeth 3b arranged at −45 degrees in the circumferential direction in the first teeth 3a and the second teeth 3b provided in staggered arrangement in the core 2.

Similarly, the second energizing circuit 6b (see a solid line) is wound around the first teeth 3a and the second teeth 3b arranged at +45 degrees in the circumferential direction and is also wound around the first teeth 3a and the second teeth 3b arranged at −45 degrees in the circumferential direction.

As a result, as shown in a lower stage of FIG. 16, magnetic paths (NA→SA) having the inclination of +45 degrees in an arrow direction with respect to the axial center direction (vertical direction in the drawing) and magnetic paths (NB→SB) having the inclination of −45 degrees are respectively formed between the first teeth 3a and the second teeth 3b in the first energizing circuit 6a and the second energizing circuit 6b (see the long frames E1, E2). Accordingly, magnetic fluxes become opposite to each other and cancelled out in adjacent magnetic paths formed between the first teeth 3a and the second teeth 3b, as a result, it becomes difficult to measure the torque.

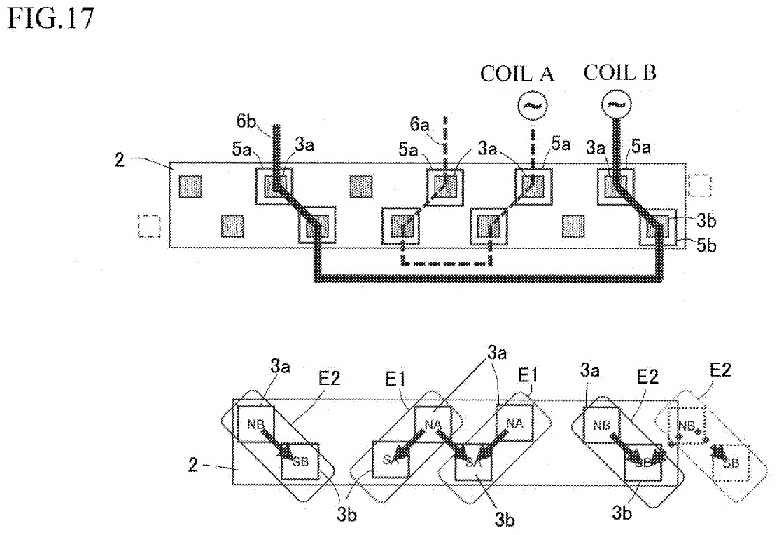

FIG. 17 is a comparative arrangement view of the core and magnetic poles formed at the teeth by energization, which is not capable of being applied to the torque detection sensor 1 according to Embodiment 3 (FIG. 5).

In an upper stage of FIG. 17, wirings of the first energizing circuit 6a (see a broken line) and the second energizing circuit 6b (see a solid line) in the first teeth 3a and the second teeth 3b provided in staggered arrangement in the core 2 are the same as those of FIG. 5. However, as shown in a lower stage of FIG. 17, directions of the first coils 5a wound around the first teeth 3a are opposite.

As a result, as shown in the lower stage of FIG. 17, a magnetic path (NA→SA) having the inclination of +45 degrees and a magnetic path (NA→SA) having the inclination of −45 degrees in arrow directions are respectively formed between the same first tooth 3a and plural second teeth 3b, for example, in the first energizing circuit 6a. Accordingly, magnetic fluxes become opposite to each other and cancelled out in adjacent magnetic paths formed between the first teeth 3a and the second teeth 3b, which reduces sensitivity.

Similarly, a magnetic path (NB→SB) having the inclination of +45 degrees and a magnetic path (NB→SB) having the inclination of −45 degrees in arrow directions are respectively formed between the same first tooth 3a and plural second teeth 3b in the second energizing circuit 6b. Accordingly, magnetic fluxes become opposite to each other and cancelled out in adjacent magnetic paths formed between the first teeth 3a and the second teeth 3b, which reduces sensitivity.

As explained above, the plural first teeth 3a and second teeth 3b provided to protrude in staggered arrangement in the annular core 2 in the circumferential direction, and the plural energizing circuits in which the first coils 5a and the second coils 5b with different winding directions wound around the first teeth 3a and the second teeth 3b are connected in series are provided; therefore, the annular core 2a, the first teeth 3a and the second teeth 3b can be manufactured through manufacturing processes similar to a laminated core used for a stator core of a motor, and the first coils 5a and the second coils 5b can be wound by using a winding machine; therefore, the sensor can be reduced in size in the radial direction and can be mass produced at low cost.

Moreover, the plural magnetic paths having the inclination of +45 degrees and the plural magnetic paths having the inclination of −45 degrees with respect to the axial center direction are respectively formed between the first teeth 3a and the second teeth 3b through the object to be detected by energization to the plural energization circuits. Accordingly, compressive stress and tensile stress generated over the entire periphery of the object to be detected can be delicately detected without reducing detection sensitivity by measuring variation of magnetic permeability as variation of coil impedance in plural magnetic circuits.

The torque detection sensor 1 according to the embodiment can detect torques of not only the solid shaft but also the hollow shaft as the object to be detected S.

The core 2 and the teeth 3 in the laminated type have been explained; however, the core 2 and the teeth 3 are not limited to this, but may be formed by machining or wire-cutting a block-shaped magnetic material or some other methods.

What is claimed is:

1. A torque detection sensor of a self-excitation type that measures variation of magnetic permeability by variation of coil impedance in magnetic circuits formed between a core and an object to be detected by energizing coils wound around teeth provided to protrude from the annular core provided around the object to be detected at plural places, the sensor comprising:
first teeth and second teeth provided to protrude in staggered arrangement in the annular core in a circumferential direction; and
a plurality of energizing circuits in which first coils and second coils with different winding directions wound around the first teeth and the second teeth are connected in series,
wherein a plurality of magnetic paths having an inclination of +45 degrees and a plurality of magnetic paths having an inclination of −45 degrees with respect to an axial center direction are respectively formed through the object to be detected between the first teeth and the second teeth by energization to the plural energizing circuits.

2. The torque detection sensor according to claim 1, wherein the first coils and the second coils connected to the same energizing circuit in series are respectively wound around the first teeth and the second teeth forming the magnetic paths having the inclination of +45 degrees with respect to the axial center direction, the first coils and the second coils connected to the same energizing circuit in series are respectively wound around the first teeth and the second teeth forming the magnetic paths having the inclination of −45 degrees with respect to the axial center direction, and the first teeth and the second teeth adjacent to each other in the annular core in the circumferential direction are alternately excited to N-poles and S-poles.

3. The torque detection sensor according to claim 1, comprising:
a first energizing circuit performing energization from the first coil wound around the first tooth to the second coil wound around the second tooth having a phase difference of +45 degrees in the circumferential direction, and performing energization from the second coil wound around another second tooth wired in the circumferential direction to the first coil wound around another first tooth having the phase difference of +45 degrees; and
a second energizing circuit performing energization from the first coil wound around the first tooth to the second coil wound around the second tooth having a phase difference of −45 degrees and performing energization from the second coil wound around another second tooth wired in the circumferential direction to the first coil wound around another first tooth having the phase difference of −45 degrees.

4. The torque detection sensor according to claim 1, wherein the sensor is a self-excitation sensor measuring variation of magnetic permeability by variation of coil impedance in magnetic circuits formed between the core and the object to be detected by energizing the first coils wound around the first teeth and the second coils wound around the second teeth provided to protrude in staggered arrangement in the core.
